(19) United States
(12) Patent Application Publication
(10) Pub. No.: US 2023/0020396 A1
(43) Pub. Date: Jan. 19, 2023

(54) SEGMENTED OPTICAL COMPONENTS AND METHODS

(71) Applicant: Arizona Board Of Regents On Behalf Of The University Of Arizona, Tucson, AZ (US)

(72) Inventors: Thomas D. Milster, Tucson, AZ (US); Young-Sik Kim, Tucson, AZ (US); Zichan Wang, Tucson, AZ (US)

(21) Appl. No.: 17/786,025

(22) PCT Filed: Dec. 16, 2020
(86) PCT No.: PCT/US2020/065393

§ 371 Date: Jun. 16, 2022

Related U.S. Application Data
(60) Provisional application No. 62/948,671, filed on Dec. 16, 2019.

(51) Int. Cl. G02B 27/42; G02B 5/18

(52) U.S. Cl. CPC G02B 27/4211; G02B 27/4216; G02B 5/1876

(57) ABSTRACT

A segmented optical component comprises a multi-order diffractive engineered surface (MODE) lens that is a high-performance ultralightweight optical element that is well suited for use as an efficient large aperture space telescope and other applications. The MODE lens also has the added benefit of reducing the range of focal dispersion versus wavelength, or lateral chromatic dispersion, and off-axis aberration, or zonal field shift (ZFS). The MODE lens can be combined with a DFL. The MODE lens comprises a curved front surface having an M-order diffractive pattern formed therein that segments the MODE lens into Np zones, each comprising a respective zone lens, where Np is greater than or equal to two. Each zone lens operates geometrically as a separate optical element and is separated from an adjacent zone by a transition having a step height.

### CROSS-REFERENCE TO RELATED APPLICATIONS

This Patent Cooperation Treaty (PCT) international application claims priority to, and the benefit of the filing date of, U.S. provisional application No. 62/948,671, filed on Dec. 16, 2019, entitled “SEGMENTED OPTICAL COMPONENTS,” which is incorporated herein by reference in its entirety.

### TECHNICAL FIELD

The present disclosure is directed to segmented optical components that can be configured to meet small size, weight and power (SWAP) requirements, and especially space-based or drone-based optical systems.

### BACKGROUND

The application for large-aperture space telescopes presents certain optical and mechanical constraints on practical implementation of new technology. First, the optical performance must meet science requirements of the mission. These missions often, but not always, require diffraction-limited imaging. An example of a non-diffraction limited mission requirement is the spectroscopic measurement of a transiting exoplanet, where, while the star and planet system remain spatially unresolved, temporal modulations in the combined spectroscopic signal are used to characterize the planetary atmosphere's transmission spectrum. Second, the system must be as simple as possible and robust in the difficult environment of space. Large aperture diffractive lenses are a new concept in space telescope design. Single-harmonic diffractive Fresnel lenses (DFLs) have been proposed for this purpose. Such lenses, however, exhibit a wide range of focal dispersion versus wavelength.

A need exists for a high-performance ultralightweight diffractive optical element that is well suited for use in space telescopes and that exhibits minimized, or at least reduced, focal dispersion versus wavelength.

### SUMMARY

The present disclosure discloses segmented optical components and methods. The segmented optical component comprises a multi-order diffractive engineered surface (MODE) lens comprising a curved front MODE lens surface and a back MODE lens surface. The front MODE lens surface has an M-order diffractive pattern formed therein that extends from a center of the MODE lens to a periphery of the MODE lens, where M is a positive integer that is greater than or equal to two, the M-order diffractive pattern segmenting the MODE lens into Np multi-order diffractive (MOD) zones, where Np is a positive integer that is greater than or equal to two.

In accordance with a representative embodiment, each MOD zone comprises a respective MOD zone lens. A first MOD zone of the Np MOD zones is a central MOD zone of the MODE lens that includes the center of the MODE lens, and an Np^{th} MOD zone of the Np MOD zones is an outermost MOD zone of the Np MOD zones that includes the periphery of the MODE lens. Each MOD zone is separated from an adjacent zone by a transition having a step height. Each MOD zone has a thickness, t, equal to a distance between a tip of the respective transition point and a back MOD zone surface at the respective MOD zone.

In accordance with a representative embodiment, the curved front MODE lens surface is defined by a function, s, and each MOD zone lens has an effective axial vertex that is set forward from the adjacent MOD zone lens in the direction from the center MOD zone lens toward the Np^{th} MOD zone lens by a distance equal to (p−1)Mh−s, where h is equal to one wavelength of optical path difference (OPD) in air at a design wavelength, λ₀, of the segmented optical component.

In accordance with a representative embodiment, the function s is a function defining a spherical surface with center of curvature at a center of an image plane of the MOD lens.

In accordance with a representative embodiment, the function s is a function defining an aspherical surface.

In accordance with a representative embodiment, the MODE lens is configured to eliminate or at least significantly reduce zonal field shift (ZFS), wherein ZFS can be para-axially expressed as: Δy̅=(p−1)Mhū/n−sū, where n is a refractive index of a material comprising the MOD lens, y is a marginal ray height, and ū is paraxial chief ray angle, and y̅ is a chief ray height.

In accordance with a representative embodiment, a ratio of ZFS expressed as Δy̅=(p−1)Mhū/n−sū to an Airy spot diameter equal to 1.22χ/NA gives a ZFS ratio, r_{zfs}, where k is the design wavelength of the MOD lens and NA is the numerical aperture value of the MODE lens, and wherein r_{zfs} is less than or equal to 5.

In accordance with a representative embodiment, a ratio of ZFS expressed as Δy̅=(p−1)Mhū/n−sū to an Airy spot diameter equal to 1.22λ/NA gives a ZFS ratio, r_{zfs}, where k is the design wavelength of the MODE lens and NA is the numerical aperture value of the MODE lens, and wherein r_{zfs} is less than or equal to 3.

In accordance with a representative embodiment, a ratio of ZFS expressed as Δy̅=(p−1)Mhū/n−sū to an Airy spot diameter equal to 1.22λ/NA gives a ZFS ratio, r_{zfs}, where k is the design wavelength of the MOD lens and NA is the numerical aperture value of the MODE lens, and wherein r_{zfs} is less than or equal to 1.

In accordance with a representative embodiment, the back MODE lens surface comprises a segmented diffractive Fresnel lens (DFL).

In accordance with a representative embodiment, the segmented DFL is a single-harmonic DFL.

In accordance with a representative embodiment, the segmented DFL is a multiple-harmonic DFL.

The method improves off-axis aberration performance of a telescope. The method comprises providing a primary lens of a telescope comprising a segmented optical component and receiving light with the primary lens, where the segmented optical component comprises a MODE lens comprising a curved front MODE lens surface and a back MODE lens surface having a preselected surface profile. The curved front MODE lens surface has an M-order diffractive pattern formed therein that extends from a center of the MODE lens to a periphery of the MODE lens, where M is a positive integer that is greater than or equal to two. The M-order diffractive pattern segmenting the MODE lens into Np multi-order diffractive (MOD) zones, where Np is a positive integer that is greater than or equal to two. The received light is incident on the curved front MODE lens surface before being incident on the back MODE lens surface.

In accordance with a representative embodiment of the method, each MOD zone comprises a respective MOD zone lens. A first MOD zone of the Np MOD zones is a central MOD zone of the MODE lens that includes the center of the MODE lens, and an Np^{th} MOD zone of the Np MOD zones is an outermost MOD zone of the Np MOD zones that includes the periphery of the MODE lens. Each MOD zone is separated from an adjacent zone by a transition having a step height. Each MOD zone has a thickness, t, equal to a distance between a tip of the respective transition point and a back MOD zone surface at the respective MOD zone.

In accordance with a representative embodiment of the method, the curved front MODE lens surface is defined by a function, s, and each MOD zone lens has an effective axial vertex that is set forward from the adjacent MOD zone lens in the direction from the center MOD zone lens toward the Np^{th} MOD zone lens by a distance equal to (p−1)Mh−s, where h is equal to one wavelength of optical path difference (OPD) in air at a design wavelength, λ₀, of the segmented optical component.

In accordance with a representative embodiment of the method, the function s is a function defining a spherical surface with center of curvature at a center of an image plane of the MOD lens.

In accordance with a representative embodiment of the method, the function s is a function defining an aspherical surface.

In accordance with a representative embodiment of the method, the MODE lens is configured to eliminate or at least significantly reduce zonal field shift (ZFS), wherein ZFS can be para-axially expressed as: Δy̅=(p−1)Mhū/n−sū, where n is a refractive index of a material comprising the MOD lens, y is a marginal ray height, and a is paraxial chief ray angle, and y is a chief ray height.

In accordance with a representative embodiment of the method, a ratio of ZFS expressed as Δy̅=(p−1)Mhū/n−sū to an Airy spot diameter equal to 1.22λ/NA gives a ZFS ratio, r_{zfs}, where k is the design wavelength of the MOD lens and NA is the numerical aperture value of the MODE lens, and wherein r_{zfs} is less than or equal to 5.

In accordance with a representative embodiment of the method, a ratio of ZFS expressed as Δy̅=(p−1)Mhū/n−sū to an Airy spot diameter equal to 1.22λ/NA gives a ZFS ratio, r_{zfs}, where k is the design wavelength of the MODE lens and NA is the numerical aperture value of the MODE lens, and wherein r_{zfs} is less than or equal to 3.

In accordance with a representative embodiment of the method, a ratio of ZFS expressed as Δy̅=(p−1)Mhū/n−sū to an Airy spot diameter equal to 1.22λ/NA gives a ZFS ratio, r_{zfs}, where k is the design wavelength of the MOD lens and NA is the numerical aperture value of the MODE lens, and wherein r_{zfs} is less than or equal to 1.

In accordance with a representative embodiment of the method, the back MODE lens surface comprises a segmented diffractive Fresnel lens (DFL).

In accordance with a representative embodiment of the method, the segmented DFL is a single-harmonic DFL.

In accordance with a representative embodiment of the method, the segmented DFL is a multiple-harmonic DFL.

These and other features and advantages of the segmented optical component and method will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 shows the segmented optical component in accordance with a representative embodiment comprising a MODE lens having a high-harmonic multiple-order diffractive (MOD) lens on the front surface and a DFL on the back surface.

FIGS. 2A-2C show a side view of a traditional achromatic doublet lens, a side view of a planar-front MODE lens, and a side view of a curved-front MODE lens in accordance with a representative embodiment, respectively.

FIG. 3A shows an on-axis spot diagram of planar-front MODE design shown in FIG. 2B.

FIG. 3B shows a maximum field angle spot diagram of planar-front MODE design shown in FIG. 2B.

FIG. 3C shows a maximum field angle spot diagram of the ZFS-free MODE design shown in FIG. 2C.

FIG. 3D shows a maximum field angle spot diagram of spherical-front MODE design.

FIGS. 4A and 4B show side views of a planar-front MODE lens 40 and a spherical-front MODE lens 41, respectively.

FIG. 5 is a zone lens model for the MODE lens shown in FIG. 4B.

FIGS. 6A and 6B are side views of two MODE lens designs in accordance with representative embodiments.

FIGS. 7A and 7B are monochromatic FFoV spot diagrams at central wavelength (658 nm) of the MODE designs shown in FIGS. 6A and 6B, respectively.

FIG. 8 is a design table showing an example of a set parameter values for a MODE lens having the curved front surface configuration depicted in FIG. 6B in accordance with a representative embodiment.

FIG. 9 is a design table for the ZFS-free lens shown in FIG. 6A in accordance with a representative embodiment.

FIG. 10 is a refractive index table for a MODE lens designed using the values listed in the tables shown in FIGS. 8 and 9.

### DETAILED DESCRIPTION

In accordance with a representative embodiment, a segmented optical component is disclosed that comprises a multi-order diffractive engineered surface (MODE) lens that is a high-performance ultralightweight optical element that is well suited for use as an efficient large aperture space telescope and other applications. The MODE lens also has the added benefit of reducing the range of focal dispersion versus wavelength, or lateral chromatic aberration (LCA), and the off-axis aberration referred to herein as zonal field shift (ZFS). In some embodiments, the MODE lens is combined with a DFL, although the segmented optical component has useful applications even in cases where it is not implemented in combination with a DFL. The MODE lens comprises a curved front surface having an M-order diffractive pattern formed therein that segments the MODE lens into Np zones, each comprising a respective zone lens, where Np is greater than or equal to two. Each zone lens operates geometrically as a separate optical element and is separated from an adjacent zone by a transition having a step height. The central p=1 zone has an axial thickness, t, which is also a thickness of each other zone, equal to a distance between a tip of the respective transition and the back surface at the respective zone. The effective axial thickness of each zone increases by an amount equal to M times h, where h is a height corresponding to one wave of optical path difference (OPD) at a design wavelength, λ₀, of the segmented optical component.

The terminology used herein is for purposes of describing particular embodiments only, and is not intended to be limiting. The defined terms are in addition to the technical, scientific, or ordinary meanings of the defined terms as commonly understood and accepted in the relevant context.

The terms “a,” “an” and “the” include both singular and plural referents, unless the context clearly dictates otherwise. Thus, for example, “a device” includes one device and plural devices. The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art. Relative terms, such as “over,” “above,” “below,” “top,” “bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

Relative terms may be used to describe the various elements' relationships to one another, as illustrated in the accompanying drawings. These relative terms are intended to encompass different orientations of the device and/or elements in addition to the orientation depicted in the drawings.

The MODE lens is a new type of high-performance ultralightweight optical element that is well suited for use as an efficient large-aperture space telescopes, among other applications, as discussed in published international application number WO 2020/014213 A1, which is incorporated by reference herein in its entirety. The initial motivation for MODE lenses is to design a new type of space telescope that provides a cost-effective solution suitable for exoplanet research through transit studies. In comparison with commonly used reflective space telescopes, MODE primary lenses have (1) unobscured apertures, (2) lightweight structures, (3) less sensitivity to manufacturing and alignment errors, (4) construction from stable optical materials compared to thin membranes, and (5) potential for easy replication in a space telescope array. The present disclosure discusses important geometrical optics design aspects of MODE lenses that can be used to improve off-axis performance, and implications of the design aspects is analyzed with physical optics simulation.

As discussed above, the application for large-aperture space telescopes presents certain optical and mechanical constraints on practical implementation, e.g., the optical performance should meet science requirements of the mission, such as diffraction-limited imaging and the system should be as simple as possible and robust in the difficult environment of space. MODE lenses for space telescope design employ a large-diameter, ultrathin glass lens as the primary focusing element in the telescope. The single lens has both diffractive and refractive properties, which are different than the single-harmonic DFLs discussed above for this purpose. One advantage of the MODE lens is that it maintains nearly the ultralight nature of a DFL, but with a greatly reduced range of focal dispersion versus wavelength, i.e., reduced LCA.

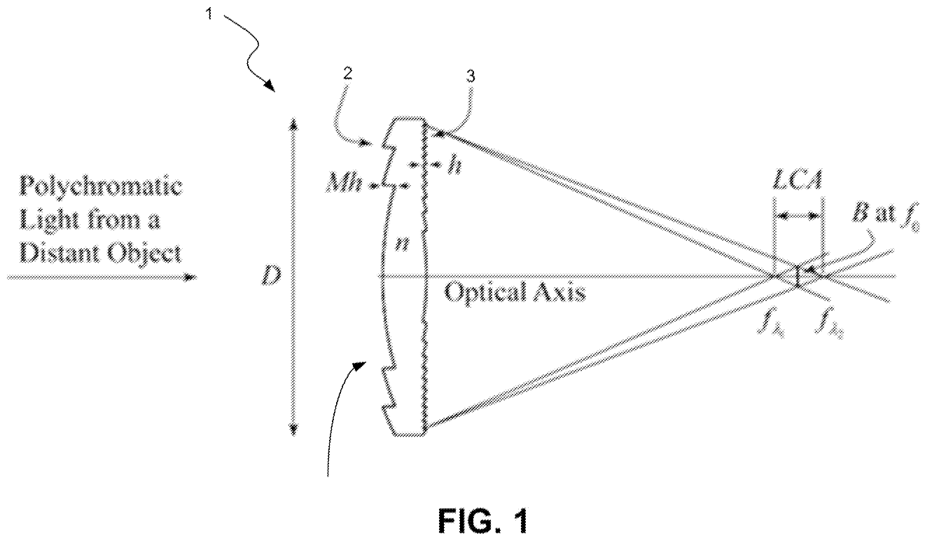

FIG. 1 shows the segmented optical component 1 in accordance with a representative embodiment comprising a MODE lens having a high-harmonic multiple-order diffractive (MOD) lens 2 on the front surface and a DFL 3 on the back surface. The MOD lens 2 comprises circularly symmetric zones that act as separate lenses directed to a common focal point f₀ at the design wavelength λ₀. The zone transitions are designed such that integer M waves of optical path difference in transmission is between the two sides of each transition at λ₀, as shown in FIG. 1 for the first zone transition with a thickness change of Mh at the boundary, where h is the surface height change for one wavelength of optical path difference (OPD) in air. In common optical glasses and plastics with refractive index n˜1.5, h is given by

h=λ₀/(n−1)≈1 μm. (1)

These MODE lenses exhibit both refractive and diffractive components of the longitudinal chromatic aberration (LCA). A high harmonic MOD surface as defined here satisfies M>250. For example, M=1000 requires a transition height of M λ₀/(n−1)˜1 mm for visible wavelengths. The back surface DFL 3 can be a single-harmonic (M=1) DFL, which has the effect of making each MOD zone achromatic to limit the refractive portion of LCA shown in FIG. 1.

Radial positions of the zone boundaries can be determined using a simple OPD model with an infinitely thin lens. Incident light rays from an on-axis source located at infinity are parallel to the optical axis at the vertex plane of the lens 1. At the lens, light rays are bent in a straight line toward the focal point f₀. OPD is defined as the difference between the length of the line and f₀. Zone transitions occur along the radius whenever the OPD is a multiple of M λ₀. For this case, zone transition radii p, are defined by

$${ρ}_{1} = {f}_{0} \sqrt{\frac{2 ( i - 1 ) M λ}{{f}_{0}} + {[ \frac{( i - 1 ) M λ}{{f}_{0}} ]}^{2}} , \qquad ( 2 )$$

where i is an integer that indicates the zone transition number. For example, i=2 identifies the transition between central zone 1 and the next radial zone, which is zone 2.

Space telescope imaging instruments (cameras) are typically designed to sample a relative narrow field of view. For example, Hubble Space Telescope's WFC3 and ACS “wide field” and “survey” cameras are designed for ˜0.05° full field. Missions with telescopes and instruments specifically designed for wide-field imaging (such as WISE and the Roman Space Telescope) have fields more than an order of magnitude larger on the largest side of about 0.78° (with Roman Space Telescope ˜200× in area compared to Hubble Space Telescope instruments). In contrast, a common cell phone telephoto lens has a 160 or larger full field.

Even though the field of view is relatively small for space telescopes, it should be well corrected to meet science requirements. The present disclosure discloses the analysis and correction of off-axis aberrations for MODE lenses. Although work has been presented in the past concerning off-axis aberrations of DFLs on flat and curved surfaces, these analyses assume that the diffracting surface is infinitely thin. While this assumption can lead to accurate results for a single-harmonic DFL, it does not accurately describe the behavior of a MODE lens, due to its high-harmonic structure. The results disclosed herein indicate that the off-axis aberration behavior of MODE lenses is well described by geometrically considering each MOD zone as a separate lens, and off-axis performance is improved by changing positions of the transition points at zone boundaries.

MOD lens structures with transition positions aligned in a plane, like the planar-front surface shown in FIG. 1, have been discussed in the literature for relatively low harmonic M numbers. Application of the theory presented in those articles to high-harmonic systems (M>250) indicate that the range of axial focal dispersion is approximately f₀/M. For example, a high-harmonic system with M=1000 and f₀=1 m results in an axial focal range of Δf˜1 mm. Higher M results in smaller Δf and smaller corresponding blur circle B. It has been demonstrated in the literature that a high-harmonic M=1000 system with a planar front displays the diffractive LCA characteristics. However, until the present invention, it was not known that a curved-front design modified for improved off-axis performance can produce the same diffractive behavior.

Although work has been reported on more complicated multi-diffractive-element harmonic diffractive lenses, such systems involve using two or more diffractive lens structures in close proximity. Such an arrangement is clearly impractical for a large-diameter primary lens on a space telescope, which would dramatically increase fabrication and alignment difficulties. In addition, the emphasis in those systems is on improving diffraction efficiency over a wide wavelength range, not in reducing the diffractive component of LCA, which is of primary importance in imaging experiments.

In the following discussion, geometrical aspects of MODE lenses are discussed, including the introduction of ZFS, which is a new type of aberration characteristic of these segmented lens systems. By curving the front of the MODE lens transition positions, ZFS can be minimized or eliminated. The diffractive behavior of MODE lenses is also discussed below.

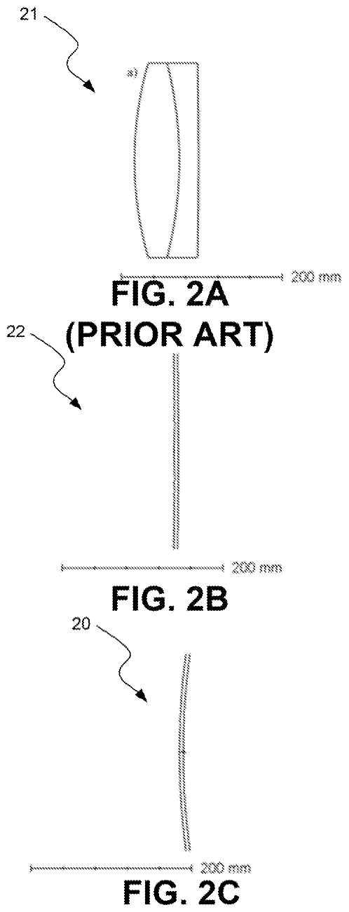

In this discussion, geometrical aspects of designing a 240 mm aperture MODE lens with M=1000 are discussed in detail, although the inventive principles and concepts are not limited to aperture size or harmonic order. By understanding that each MOD zone acts geometrically as a separate lens, it is found that shaping the MOD surface with a non-planar front significantly improves off-axis performance. Several to-scale lenses are shown in FIGS. 2A-2C for comparison purposes. FIG. 2A shows a side view of a traditional achromatic doublet lens 21 made with BK7 and SF5. FIG. 2B shows a side view of a planar-front MODE lens 22. FIG. 2C shows a side view of a curved-front MODE lens 20 in accordance with a representative embodiment. The lens 21 is more than 80-mm thick. An achromatic lens with similar performance is achieved with MODE lenses 22 and 20 that are only 5-mm thick. As a result, the volume of a MODE lenses 22 or 20 is 10 to 15 times lower than a traditional achromatic doublet lens 21. These designs are compared in the following paragraphs, along with theory that describes ZFS.

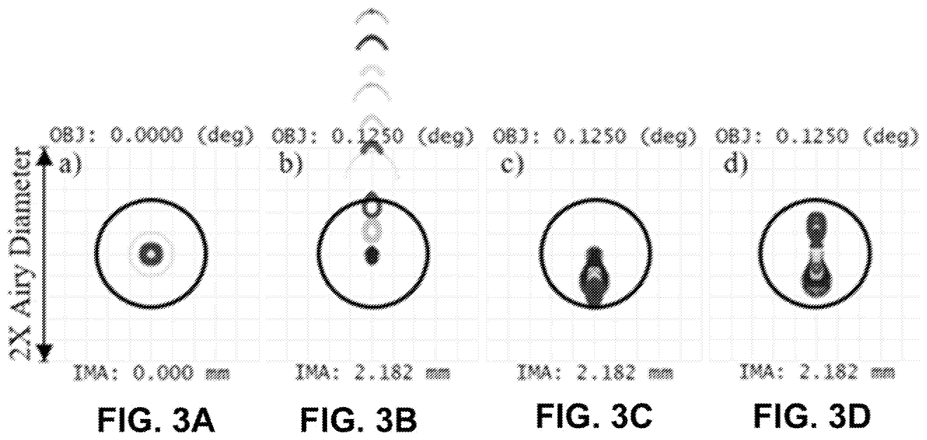

Off-axis performance of the MODE lens is severely degraded by ZFS, as will now be described with reference to FIGS. 3A-3D, which show monochromatic spot diagrams at central wavelength (658 nm) of MODE lens designs. FIG. 3A shows an on-axis spot diagram of planar-front MODE design shown in FIG. 2B. FIG. 3B shows a maximum field angle spot diagram of planar-front MODE design shown in FIG. 2B. FIG. 3C shows a maximum field angle spot diagram of the ZFS-free MODE design shown in FIG. 2C. FIG. 3D shows a maximum field angle spot diagram of spherical-front MODE design. Only the on-axis spot diagram of the flat-front design is shown, because the on-axis spots are very similar for all designs.

The black circle in FIGS. 3A-3D is the Airy disk diameter of 6.7 m at λ₀=658 nm, and the full field of view (FFoV) half angle is 0.125°, which results in a maximum image height of 2.182 mm. For experimental purposes, the MODE lens is designed with L-BSL7 glass, which is a low-temperature glass suitable for molding. The refractive index of the L-BSL7 is slightly modified to account for mold cooling at a rate of 0.5° C./sec. Ray intercepts are shown as symbols and form patterns for each zone segment of the MODE lens. If the system is completely corrected for geometrical aberrations, all ray intercepts would fall inside the Airy disk black circle diameter. The vertical separation of zonal segment ray intercepts from the center of the Airy disk increases with radius of the segment. That is, the largest-radius segment exhibits the most ZFS. As clearly indicated in FIG. 3B, the off-axis behavior of geometrical rays in a planar-front MODE design limit performance because of the ray intercepts that fall outside of the Airy disk diameter.

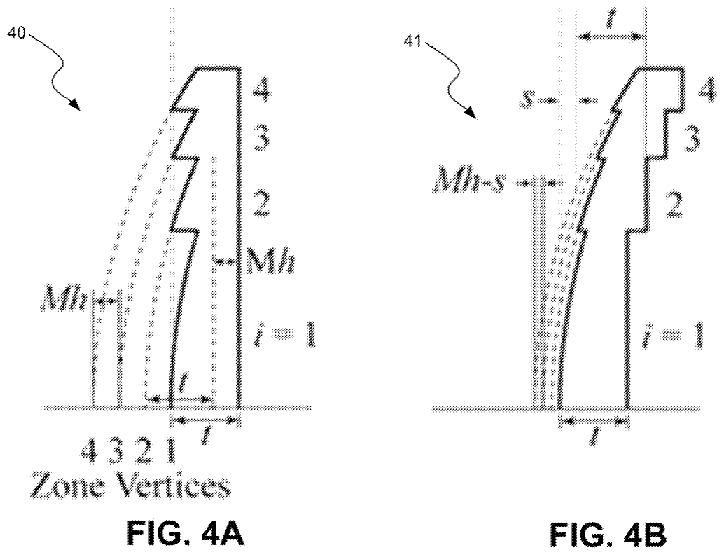

Through careful analysis it was found that ZFS can be minimized by curving the front of the MODE lens, as will now be described with reference to FIGS. 4A and 4B. FIGS. 4A and 4B show side views of a planar-front MODE lens 40 and a spherical-front MODE lens 41. Cored-out sections of effective lenses from MOD zones are shown as dotted lines. To understand effects of ZFS in FIG. 3B, a first-order geometrical analysis is performed by considering each MOD zone as a separate optical system. The first zone is a standard lens with thickness t. The second zone (i=2) is a different lens where the diameter of the first zone is effectively cored out from it and replaced with the zone 1 lens (i=1). The step height at the transition of the 1^{st} and 2^{nd} zones corresponds to the MOD number M times the height h that corresponds to one wave of OPD at the design wavelength Xo. The effective axial thickness of the second zone lens is Mh greater than the first zone lens. Although no geometrical rays pass through the cored-out section of the lens describing the second zone, it is important to keep in mind the complete zonal lens description to understand its first-order properties. Higher-number zones follow this same trend, with correspondingly larger axial distances. The vertex of each zone lens is set forward of the first zone vertex by (i−1)Mh, where i is the zone number.

The spherical-front configuration displayed in FIG. 4B is like the planar front, except each zone is setback by an amount s from the vertex of the first zone. The thickness of each zone at its first transition point is t, which is the axial thickness of the first zone. Although the effective axial thicknesses of each zone lens is the same as in the planar-front design, the distance that each lens is set forward is (i−1)Mh−s. Effectively, each zone is simply shifted toward the image, so that the transition points follow a specified function s.

The detailed analysis shows that there are certain curves s that produce a negligible amount of ZFS. The family of surfaces s that minimize ZFS is a new engineering revelation that significantly improves off-axis performance of optical systems employing ultralight MODE or MOD lenses.

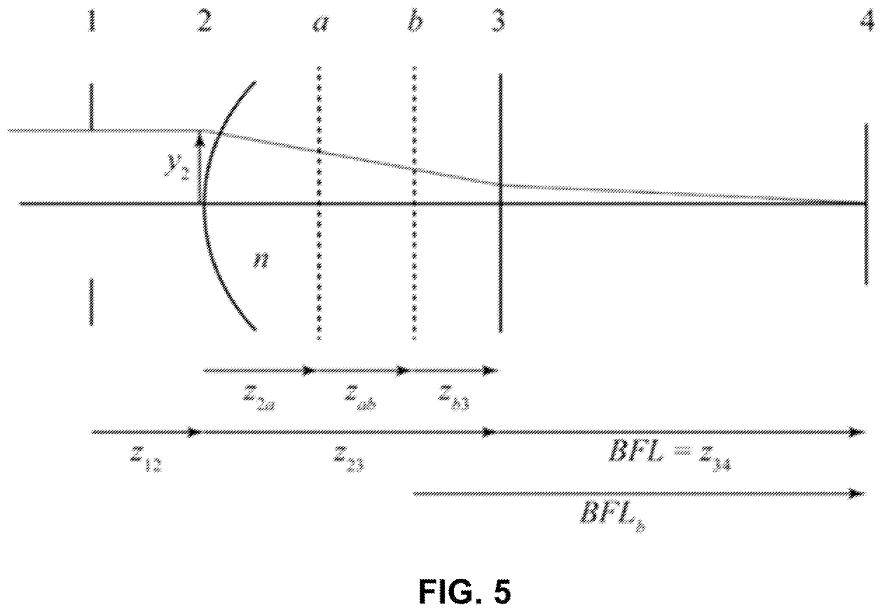

A model for the lens in each MOD zone segment is shown in FIG. 5, in which the cored-out section is replaced with the full refractive geometry. Planes 1 through 4 sequentially are the system stop, first refractive surface with power, a planar back surface and the image plane. A paraxial analysis of the lens is enough to understand its first-order optical characteristics, and the restriction of surface 3 as planar does not significantly affect the analysis. Distances z₁₂, z₂₃ and z₃₄ are standard thicknesses between surfaces. z₂ₐ is the distance between the front vertex of the zone lens and the front vertex of the p=1 lens, z_{ab} is the axial thickness of the p=1 lens, and z_{b3} is the distance between the back vertex of the p=1 lens and the back vertex of the zone lens. For the p=1 lens, both z₂ₐ and z_{b3} are zero. The system stop is placed at an arbitrary distance z₁₂ for this analysis, but in practice it is typically at the front vertex of the p=1 lens.

A paraxial raytrace with a marginal ray from infinity (ω₁=0) and ray height y₂ at surface 2 produces the following relationships (ϕ is optical power, n is refractive index, u is paraxial marginal angle, y is the marginal ray height, ū is paraxial chief ray angle, y̅ is chief ray height, and ω is marginal optical angle given by nu. Prime indicates value in the subsequent space.):

ω′₂=−y₂ϕ₂

y₃=y₂+ω′₂z₂₃/n

ω′₃=ω′₂ (3)

Effective focal length EFL is given by

$$E F L = - \frac{{y}_{2}}{{u}_{3}^{′}} = \frac{1}{{ϕ}_{2}} . \qquad ( 4 )$$

Back focal length BFL=z₃₄ for each zone is

$$B F L = - \frac{{y}_{3}}{{u}_{3}^{′}} = 1 / {ϕ}_{2} - {z}_{23} / n . \qquad ( 5 )$$

The first requirement for the focusing system is that back focal length BFL_{b} defined by BFL+z_{b3} is the same for all zones. BFL_{b} with z_{b3}=0 is the BFL for zone 1, and z_{b3}=0 for all zones of the planar geometry. In terms of first-order parameters,

BFL_{b}=BFL+z_{b3}=1/ϕ₂−z_{ab}/n−(p−1)Mh/n+s, (6)

where z₂₃ is given by z_{ab}+(p−1)Mh.

With the planar geometry, s=0, and BFL_{b} is a function of p unless ϕ₂ is also a function of p. If

1/ϕ₂=BFL_{b}+z_{ab}/n+(p−1)Mh/n

where BFL_{b} is a constant, the EFL of Eq. (3) is a function of p, and image-plane field height of the chief ray is now also a function of p, which is given by

y̅=1/ϕ₂ū=[BFL_{b}+z_{ab}/n+(p−1)Mh/n]ū. (7)

That is, the image height depends on the zone number. A single image of an object point is distributed into multiple image points aligned radially from the axis. We call this condition zonal field shift (ZFS). Deviation of the chief ray height from the zone 1 intercept is

Δy̅=(p−1)Mhū/n. (8)

ZFS increases with M and p in the planar-front design. For example, with equal BFL_{b} on all zones, an M=1000 planar MODE lens at a design wavelength of 658 nm and 0.125° field angle with n=1.5 and 11 zones produces a maximum Δy̅ of 19.1 μm, regardless of focal length, which is clearly displayed in FIG. 3 and is several times larger than the Airy spot diameter. If BFL_{b} is adjusted to compensate for the p-dependent term in Eq. (5), Δy̅=0, but the resulting geometrical blur circle diameter B for each zone is

$$B = \frac{( p - 1 ) M h}{nf \#} . \qquad ( 9 )$$

For the system mentioned above and f #=4.17, the maximum blur circle diameter is 2.1 mm. Clearly, ZFS is a limiting issue with planar-front designs.

Curved-front designs have an additional degree of freedom in the choice of the function s, where Eq. (6) is used to define s with constant ϕ₂ and BFL_{b} such that

s=(p−1)Mh/n (10)

defines a transition-point function that eliminates, minimizes, or at least significantly reduces ZFS. This is referred to herein as a “ZFS-free” design. A second choice is to set s on a spherical front that is concentric with the image point, which is referred to herein as a “spherical-front” design. The functional form of s in this case is

s=f₀−\sqrt{f₀²−ρₚ²}, (11)

where f₀ is the design EFL and ρₚ is the radius of the zone transition defined by

$${ρ}_{p} = {f}_{0} \sqrt{\frac{2 ( p - 1 ) M λ}{{f}_{0}} - {[ \frac{( p - 1 ) M λ}{{f}_{0}} ]}^{2}} . \qquad ( 12 )$$

More generally for any function s, zone transition radii are found from

$${ρ}_{p} = {f}_{0} \sqrt{\frac{2 ( p - 1 ) M λ}{{f}_{0}} + {[ \frac{( p - 1 ) M λ}{{f}_{0}} ]}^{2} - \frac{2 s}{{f}_{0}^{2}}} , \qquad ( 13 )$$

and the general paraxial expression for ZFS is

Δy̅=(p−1)Mhū/n−sū. (14)

The ratio of Eq. (12) to the Airy spot diameter is a useful metric for defining an improved optical system using a MODE lens. This ratio is the ZFS ratio and is defined by

$${r}_{Z F S} = \frac{{[ ( p - 1 ) M h \overline{u} / n - s \overline{u} ]}_{max}}{1.22 λ / NA} , \qquad ( 15 )$$

where the bracketed value is evaluated at its maximum value and NA is numerical aperture of the MODE lens. Values of r_{ZFS}≤1 define a system that is diffraction limited, and values of r_{ZFS} greater than one are often acceptable, up to a maximum value that depends on the application.

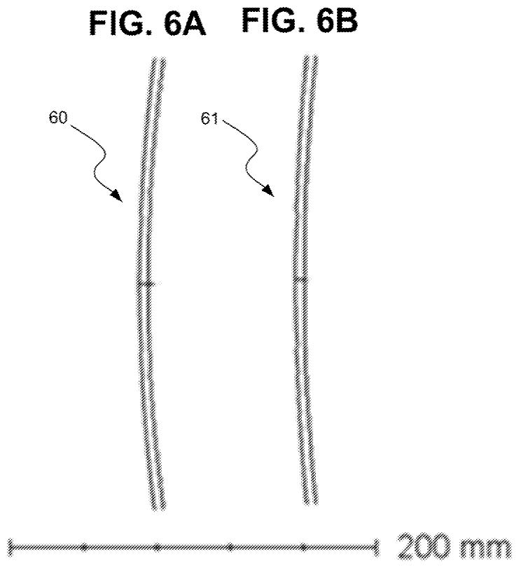

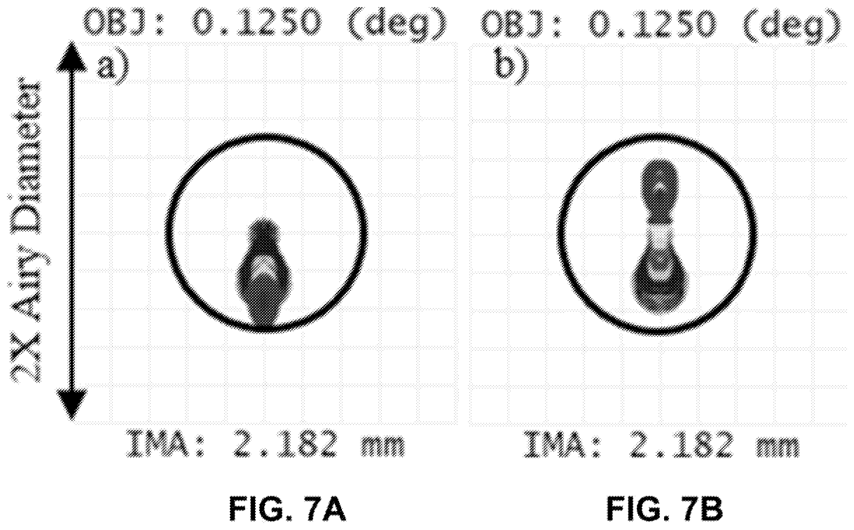

Representative embodiments of two to-scale lenses are shown in FIGS. 6A and 6B that have specific s functions. FIG. 6A shows a ZFS-free MODE design lens 60. FIG. 6B shows a spherical-front MODE design lens 61. For both designs, r_{ZFS}<1, as can be observed from the spot diagrams of FIGS. 7A and 7B. The lenses 60 and 61 have lens apertures of 240 mm in diameter and design focal lengths f₀=1 m. They are optimized for R-band from 589 nm to 727 nm with a center wavelength of 658 nm. The full field of view (FFoV) half angle is 0.125°, which results in a maximum image height of 2.182 mm. MODE lenses are designed with L-BSL7 glass, which is a low-temperature glass suitable for molding. The refractive index of the L-BSL7 is slightly modified to account for mold cooling at a rate of 0.5° C./sec.

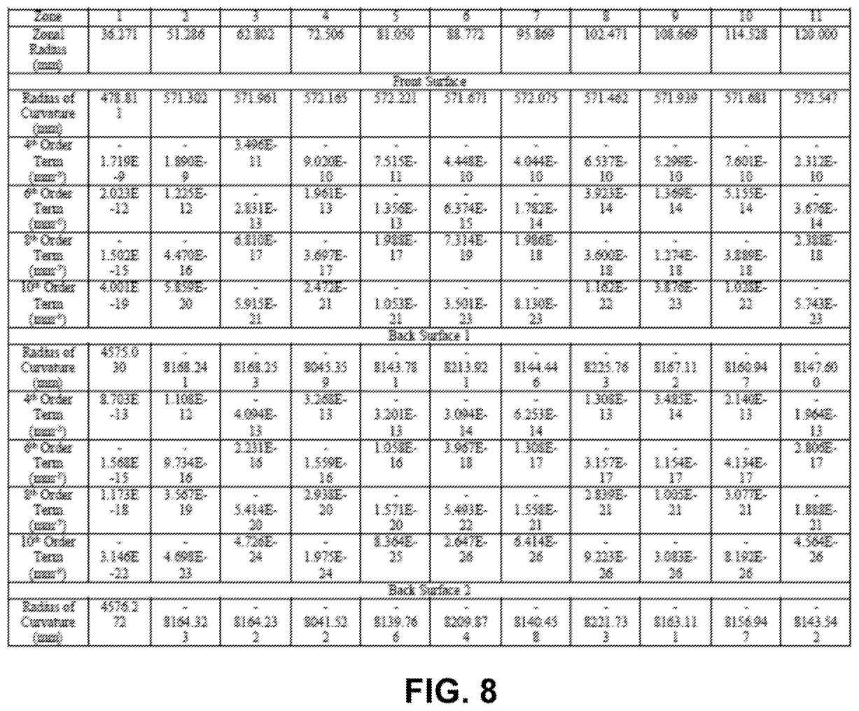

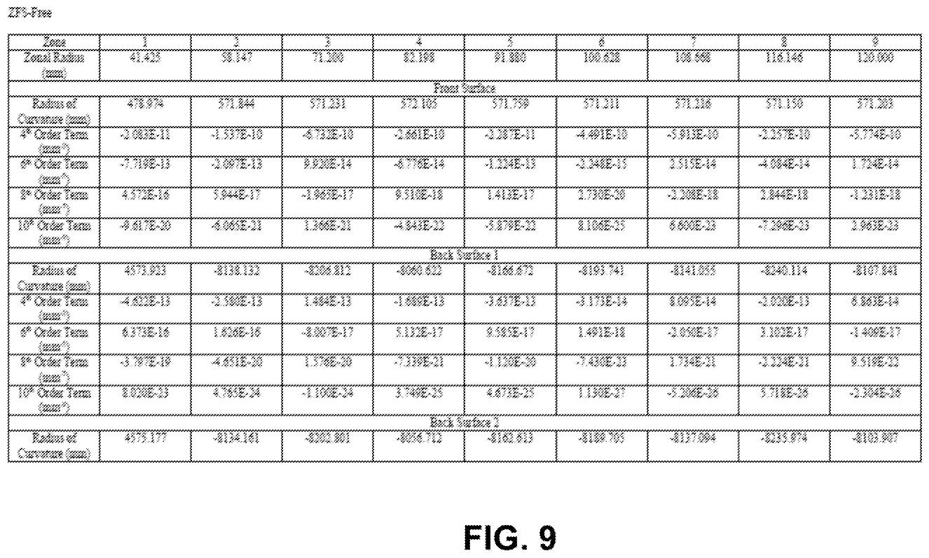

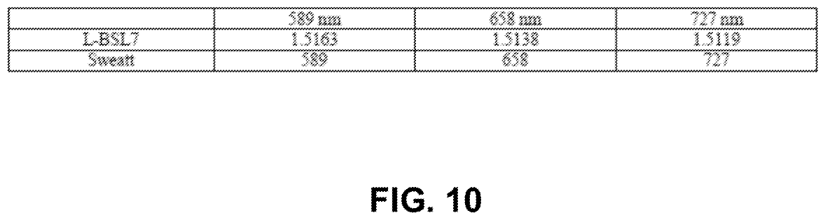

FIG. 8 is a lens design table for the spherical-front MODE design lens 61 of FIG. 6B that lists values that can be used for the spherical-front design. FIG. 9 is a lens design table for the ZFS-free MODE design lens 60 shown in FIG. 6A. FIG. 10 is a refractive index table for values used in the designs having the values listed in FIGS. 8 and 9. It should be noted that the inventive principles and concepts are not limited to lens that are designed using the values listed in these tables, but the tables provide examples of values that can be used to achieve suitable lens designs for various applications. The set of parameter values and refractive index values will vary depending on the application for which the lens is used and on other requirements, such as size and weight requirements, for example. Therefore, the lenses in accordance with the inventive principles and concepts are not limited to the values shown in FIGS. 8, 9, and 10.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

What is claimed is:

1. A segmented optical component comprising:
a multi-order diffractive engineered surface (MODE) lens comprising:
a curved front MODE lens surface having an M-order diffractive pattern formed therein that extends from a center of the MODE lens to a periphery of the MODE lens, where M is a positive integer that is greater than or equal to two, the M-order diffractive pattern segmenting the MODE lens into Np multi-order diffractive (MOD) zones; and
a back MODE lens surface having a preselected back surface profile.

2. The segmented optical component of claim 1, wherein each MOD zone comprises a respective MOD zone lens, where Np is a positive integer that is greater than or equal to two, a first MOD zone of the Np MOD zones being a central MOD zone of the MODE lens that includes the center of the MODE lens, an Np^{th} MOD zone of the Np MOD zones being an outermost MOD zone of the Np MOD zones that includes the periphery of the MODE lens, each MOD zone being separated from an adjacent zone by a transition having a step height, each MOD zone having a thickness, t, equal to a distance between a tip of the respective transition point and a back MOD zone surface at the respective MOD zone.

3. The segmented optical component of claim 2, wherein the curved front MODE lens surface is defined by a function, s, and wherein each MOD zone lens has an effective axial vertex that is set forward from the adjacent MOD zone lens in the direction from the center MOD zone lens toward the Np^{th} MOD zone lens by a distance equal to (p−1)Mh−s, where h is equal to one wavelength of optical path difference (OPD) in air at a design wavelength, λ₀, of the segmented optical component.

4. The segmented optical component of claim 3, wherein the function s is a function defining a spherical surface with center of curvature at a center of an image plane of the MOD lens.

5. The segmented optical component of claim 3, wherein the function s is a function defining an aspherical surface.

6. The segmented optical component of claim 1, wherein the MODE lens is configured to eliminate or at least significantly reduce zonal field shift (ZFS), wherein ZFS can be para-axially expressed as: Δy̅=(p−1)Mhū/n−sū, where n is a refractive index of a material comprising the MOD lens, y is a marginal ray height, and ū is paraxial chief ray angle, and y̅ is a chief ray height.

7. The segmented optical component of claim 6, wherein a ratio of ZFS expressed as Δy̅=(p−1)Mhū/n−sū to an Airy spot diameter equal to 1.22χ/NA gives a ZFS ratio, r_{zfs}, where k is the design wavelength of the MOD lens and NA is the numerical aperture value of the MODE lens, and wherein r_{zfs} is less than or equal to 5.

8. The segmented optical component of claim 7, wherein a ratio of ZFS expressed as Δy̅=(p−1)Mhū/n−sū to an Airy spot diameter equal to 1.22λ/NA gives a ZFS ratio, r_{zfs}, where k is the design wavelength of the MODE lens and NA is the numerical aperture value of the MODE lens, and wherein r_{zfs} is less than or equal to 3.

9. The segmented optical component of claim 8, wherein a ratio of ZFS expressed as Δy̅=(p−1)Mhū/n−sū to an Airy spot diameter equal to 1.22λ/NA gives a ZFS ratio, r_{zfs}, where k is the design wavelength of the MOD lens and NA is the numerical aperture value of the MODE lens, and wherein r_{zfs} is less than or equal to 1.

10. The segmented optical component of claim 1, wherein the back MODE lens surface comprises a segmented diffractive Fresnel lens (DFL).

11. The segmented optical component of claim 10, wherein the segmented DFL is a single-harmonic DFL.

12. The segmented optical component of claim 10, wherein the segmented DFL is a multiple-harmonic DFL.

13. A method for removing off-axis aberration performance of a telescope, the method comprising:
providing a primary lens of a telescope, the primary lens comprising a segmented optical component comprising a multi-order diffractive engineered surface (MODE) lens, the MODE lens comprising a curved front MODE lens surface and a back MODE lens surface having a preselected surface profile, the curved front MODE lens surface having an M-order diffractive pattern formed therein that extends from a center of the MODE lens to a periphery of the MODE lens, where M is a positive integer that is greater than or equal to two, the M-order diffractive pattern segmenting the MODE lens into Np multi-order diffractive (MOD) zones; and
receiving light with the primary lens, the received light being incident on the curved front MODE lens surface before being incident on the back MODE lens surface.

14. The method of claim 13, wherein each MOD zone comprises a respective MOD zone lens, where Np is a positive integer that is greater than or equal to two, a first MOD zone of the Np MOD zones being a central MOD zone of the MODE lens that includes the center of the MODE lens, an Np^{th} MOD zone of the Np MOD zones being an outermost MOD zone of the Np MOD zones that includes the periphery of the MODE lens, each MOD zone being separated from an adjacent zone by a transition having a step height, each MOD zone having a thickness, t, equal to a distance between a tip of the respective transition point and a back MOD zone surface at the respective MOD zone.

15. The method of claim 14, wherein the curved front MODE lens surface is defined by a function, s, and wherein each MOD zone lens has an effective axial vertex that is set forward from the adjacent MOD zone lens in the direction from the center MOD zone lens toward the Np^{th} MOD zone lens by a distance equal to (p−1)Mh−s, where h is equal to one wavelength of optical path difference (OPD) in air at a design wavelength, λ₀, of the segmented optical component.

16. The method of claim 15, wherein the function s is a function defining a spherical surface with center of curvature at a center of an image plane of the MODE lens.

17. The method of claim 15, wherein the function s is a function defining an aspherical surface.

18. The method of claim 13, wherein the back surface of the MOD lens comprises a segmented diffractive Fresnel lens (DFL).

19. The method of claim 18, wherein the segmented DFL is a single-harmonic DFL.

20. The method of claim 18, wherein the segmented DFL is a multiple-harmonic DFL.
